(19) United States
(12) Patent Application Publication
(10) Pub. No.: US 2026/0326566 A1
(43) Pub. Date: Oct. 22, 2026

(54) VEHICULAR ALERT SYSTEM WITH REAR WINDOW DISPLAY

(71) Applicant: Magna Electronics Inc., Auburn Hills, MI (US)

(72) Inventors: Ramallingeswara Rao P, Andhra Pradesh (IN); Nanubala Guru Siva Prasad, Karnataka (IN)

(21) Appl. No.: 19/650,692

(22) Filed: Apr. 17, 2026

Related U.S. Application Data
(60) Provisional application No. 63/791,778, filed on Apr. 21, 2025.

(51) Int. Cl. B60K 35/81; B60K 35/22; B60K 35/28

(52) U.S. Cl. CPC B60K 35/81; B60K 35/22; B60K 35/28; B60K 2360/178; B60K 2360/1868; B60K 2360/21; B60K 2360/785

(57) ABSTRACT

A vehicular sensing system includes a sensor disposed at a vehicle and that senses exterior of the vehicle and at least forward of the vehicle. A display device is disposed at a rear window of the vehicle and, when electrically operated to display images, displays images that are viewable by a person exterior of the vehicle and at least rearward of the vehicle. The system, based on the vehicle being at or near an intersection of a road, and via processing at an electronic control unit (ECU) of sensor data captured by the sensor, determines a condition of the intersection. The system operates the display to display an image that is representative of the determined condition of the intersection.

### CROSS REFERENCE TO RELATED APPLICATION

The present application claims the filing benefits of U.S. provisional application Ser. No. 63/791,778, filed Apr. 21, 2025, which is hereby incorporated herein by reference in its entirety.

### FIELD OF THE INVENTION

The present invention relates generally to a vehicle vision system for a vehicle and, more particularly, to a vehicle vision system that utilizes one or more cameras at a vehicle.

### BACKGROUND OF THE INVENTION

Use of imaging sensors in vehicle imaging systems is common and known.

Examples of such known systems are described in U.S. Pat. Nos. 5,949,331; 5,670,935 and/or 5,550,677, which are hereby incorporated herein by reference in their entireties.

### SUMMARY OF THE INVENTION

A driving assistance system or vision system or sensing system or imaging system for a vehicle utilizes one or more cameras (preferably one or more CMOS cameras) to capture image data representative of images exterior of the vehicle, and determines a condition of the road ahead of the vehicle, such as a condition of an intersection ahead of the vehicle. The vehicle is equipped with an at least partially transparent display device disposed at or near a rear window of the vehicle and the system operates the display device to display images or icons or messages representative of the determined condition.

For example, a vehicular sensing system may include a sensor disposed at a vehicle equipped with the vehicular sensing system, and the sensor senses exterior of the equipped vehicle and at least forward of the equipped vehicle and is operable to capture sensor data. Electronic circuitry of an electronic control unit (ECU) includes a data processing operable to process sensor data captured by the sensor. A display device is disposed at a rear window of the equipped vehicle and, when electrically operated to display images, the display device displays images that are viewable by a person exterior of the equipped vehicle and at least rearward of the equipped vehicle. The vehicular sensing system, based on the equipped vehicle being at or near an intersection of a road, and via processing at the ECU of sensor data captured by the sensor and transferred to the ECU, may determine a condition of the intersection. The vehicular sensing system operates the display device to display an image that is representative of the determined condition of the intersection.

These and other objects, advantages, purposes and features of the present invention will become apparent upon review of the following specification in conjunction with the drawings.

### BRIEF DESCRIPTION OF THE DRAWINGS

FIG. 1 is a plan view of a vehicle with a sensing system that incorporates cameras;

FIGS. 2 and 3 are perspective views of the vehicle, with a display device at a rear window of the vehicle being operated to display images viewable by a person exterior and rearward of the vehicle;

FIG. 4 is a schematic view of the sensing system; and

FIGS. 5A and 5B show example images that are displayed at the display device.

### DESCRIPTION OF THE PREFERRED EMBODIMENTS

A vehicle vision system and/or sensing system and/or driver or driving assist system and/or object detection system and/or alert system operates to capture images and/or sensor data exterior and/or interior of the vehicle and may process the captured image data and/or sensor data to display images and to detect objects at or near the vehicle and in the predicted path of the vehicle, such as to assist a driver of the vehicle in maneuvering the vehicle in a rearward direction. The vision system includes a data processor or processing system that is operable to receive image data from one or more cameras and/or sensor data from one or more sensors and provide an output, such as to a display device for displaying images representative of the captured image data. Optionally, the vision system may provide display, such as a rearview display or a top down or bird's eye or surround view display or the like.

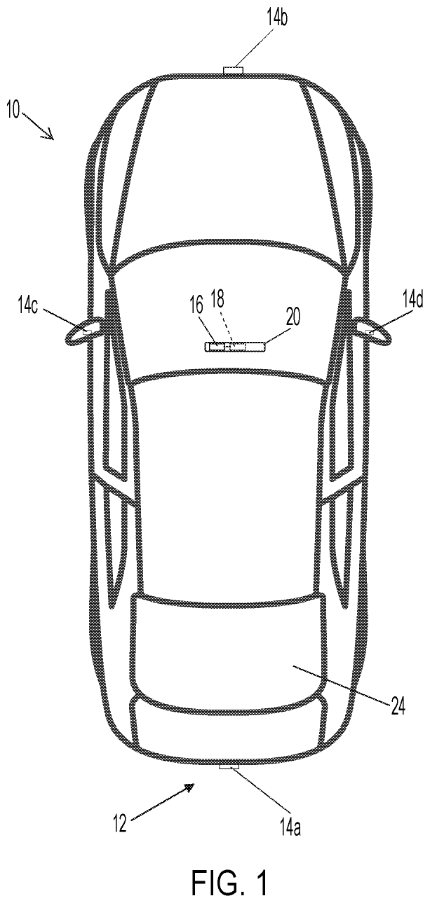

Referring now to the drawings and the illustrative embodiments depicted therein, a vehicle 10 includes an imaging system or vision system 12 that includes at least one exterior-viewing imaging sensor or camera, such as a rear backup camera or rearward-viewing imaging sensor or camera 14a (and the system may optionally include multiple exterior-viewing imaging sensors or cameras, such as a forward-viewing camera 14b at the front (or at the windshield) of the vehicle, and a sideward/rearward-viewing camera 14c, 14d at respective sides of the vehicle), which captures images exterior of the vehicle, with the camera having a lens for focusing images at or onto an imaging array or imaging plane or imager of the camera (FIG. 1). Optionally, a forward-viewing camera may be disposed at the windshield of the vehicle and view through the windshield and forward of the vehicle, such as for a machine vision system (such as for traffic sign recognition, headlamp control, pedestrian detection, collision avoidance, lane marker detection and/or the like). The vision system 12 includes a control or electronic control unit (ECU) 18 having electronic circuitry and associated software, with the electronic circuitry including a data processor or image processor that is operable to process image data captured by the camera or cameras, whereby the ECU may detect or determine presence of objects or the like and/or the system provide displayed images at a display device 16 for viewing by the driver of the vehicle (although shown in FIG. 1 as being part of or incorporated in or at an interior rearview mirror assembly 20 of the vehicle, the control and/or the display device may be disposed elsewhere at or in the vehicle). The data transfer or signal communication from the camera to the ECU may comprise any suitable data or communication link, such as a vehicle network bus or the like of the equipped vehicle.

Poor visibility, due to weather conditions, traffic congestion, road-side objects and the like, often leads to dangerous driving conditions for vehicles. For example, overtaking at intersections often places the overtaking vehicle in the path of oncoming traffic, increasing the risk of head-on collisions. These collisions can be severe due to the combined speed of both vehicles. Intersections may have limited visibility due to buildings, trees, or other vehicles. This makes it harder to see oncoming traffic or pedestrians.

Ignoring traffic signals and signs while overtaking may lead to accidents. It is crucial to obey traffic lights and road signs that indicate whether overtaking is allowed. Intersections involve multiple traffic movements, including turning vehicles, crossing pedestrians, and merging traffic. Overtaking in such a scenario may lead to confusion and accidents. In some situations, drivers may misinterpret signals. For example, a driver may think that the vehicle ahead is turning when the vehicle is actually signaling to overtake. Weather conditions such as fog, snow, rain and the like may further affect visibility.

As discussed further below, the vehicular vision system or sensing system or alert system 12 receives sensor data and/or signals from one or more sensors and/or systems of the vehicle 10 and makes determinations about the environment and driving conditions exterior the vehicle 10 and/or determinations about objects, other vehicles and pedestrians near the vehicle 10. For example, the one or more sensors may include one or more of the cameras 14a-14d. Additionally or alternatively, the one or more sensors sensing respective regions exterior of the vehicle may include one or more radar sensors, one or more ultrasonic sensors, one or more lidar sensors and the like. To improve communication and road safety, the system 12 may generate alerts or messages to drivers of other vehicles and/or pedestrians based on these determinations.

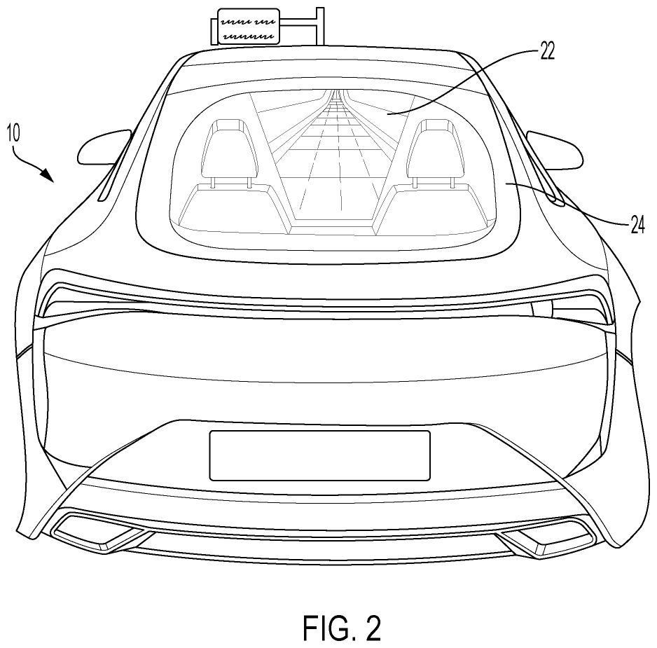

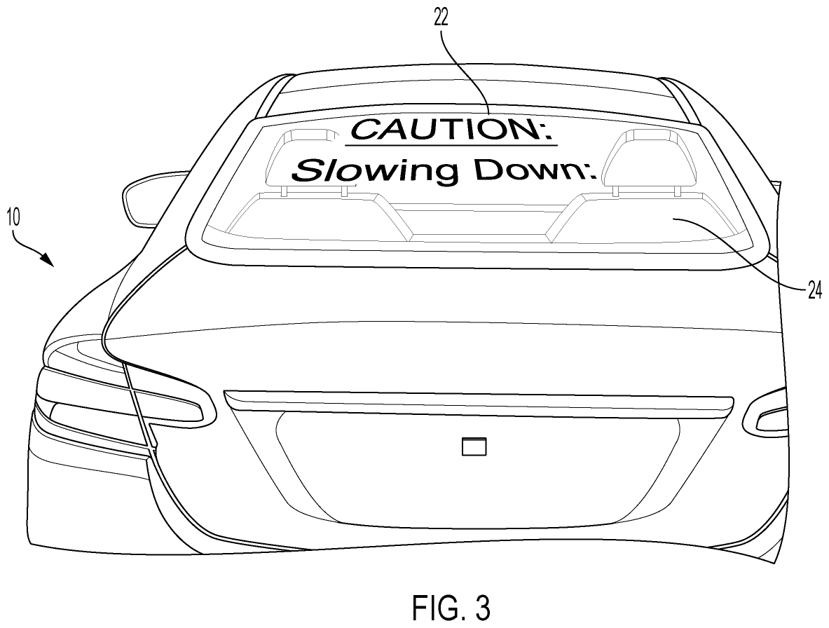

Referring to FIGS. 2-4, the vehicle 10 includes a display device 22 that is disposed at and/or visible through a rear window 24 of the vehicle 10. The system 12 generates alerts or messages or images, such as symbols, text, video images, and the like, that are displayed at the display device 22 for viewing by drivers of other vehicles and/or pedestrians rearward of the equipped vehicle 10.

In the illustrated example, the display device 22 includes an at least partially transparent display device, such as a transparent organic light emitting diode (OLED) display. This allows the driver to view from within the cabin of the vehicle 10 exterior the vehicle through the rear window 24 and the display device 22 while the display device 22 is being operated to display a message or icon or video image. In other words, the display device 22 is configured such that, when images or icons or messages are displayed at the display device 22, the displayed graphics are viewable exterior the vehicle and the displayed graphics may not be viewable interior the vehicle, with occupants of the vehicle able to view exterior of the vehicle through the window 24 and the display device 22. Thus, visibility for the driver through the rear window 24 and the display device 22 is not sacrificed during operation of the display device 22.

Optionally, the display device 22 may be disposed at or near a portion of the rear window 24 outside the view of the driver. For example, the display device 22 may be disposed at a peripheral edge region of the rear window 24, such as an upper edge region of the rear window 24 near a center high-mounted stop lamp (CHMSL) of the vehicle 10, a lower edge region of the rear window 24, and the like. In other words, the display device 22 may be disposed at or near the rear window 24 such that, when the driver views through the rear window 24 (e.g., the driver views directly through the rear window 24 and rearward of the vehicle 10 or the driver views rearward of the vehicle 10 through the rear window 24 via reflections at an interior rearview mirror of the vehicle 10), the display device 22 is disposed outside a field of view of the driver.

The display device 22 may comprise a static display and/or repeating display, such that the same image or icon or message (or a selection of images or icons or messages) is displayed each time the display 22 is operated. For example, the display device 22 may be configured to display left-facing and right-facing arrows to function as a turn signal indicator, or the display device 22 may be configured to display an image of a stop sign when the vehicle 10 is slowing down for and/or stopped at a stop sign or traffic light, and the like. Optionally, the system 12 identifies a stop sign and/or a traffic signal (e.g., a green light, a yellow light, a red light, a turning arrow, and the like) based on processing image and/or sensor data and displays a corresponding image at the display device 22 responsive to identifying the stop sign and/or the traffic signal.

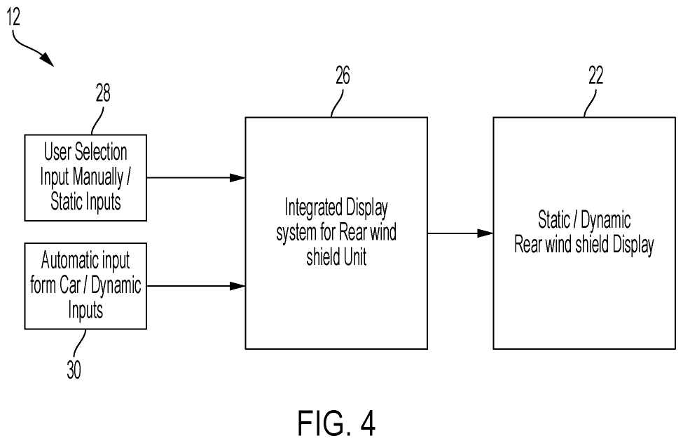

In some examples, the display device 22 may comprise a dynamic or configurable display, such that the image or icon or message displayed may be adjusted by the system 12. For example, the system 12 may include a control module 26 that activates and adjusts operation of the display 22 (FIG. 4). The control module 26 may be accommodated by electronic circuitry at the display device 22 or the control module 26 may be disposed elsewhere at the vehicle 10, such as at a central vehicle ECU.

The display device 22 may be operated responsive to a user input 28 provided within the interior cabin of the vehicle 10, such as a manual input at a button or switch, an audio input captured via a microphone within the cabin, and the like. For example, the driver may activate a turn signal indicator, hazard lights, a brake pedal, and the like and the display device 22 may activate to display a corresponding image responsive to the input. Further, the driver may adjust or configure the image or icon or message displayed, such as to display a customized message provided to the control module 26 via an audio input (e.g., a spoken command) or typed using a keyboard displayed at a display screen of an infotainment system of the vehicle 10.

Moreover, the display device 22 may be operated automatically (i.e., without a user input) responsive to a signal or input 30 from one or more sensors or systems of the vehicle 10. The system 12 may operate the display device 22 based on processing of image data captured by the one or more cameras at the vehicle 10, based on processing of sensor data captured by one or more other sensors at the vehicle (e.g., radar sensors, lidar sensors, ultrasonic sensors, and the like), based on signals from a Global Positioning System (GPS) of the vehicle, based on vehicle dynamic data (e.g., vehicle speed, vehicle acceleration, and the like), and the like. The system may receive real-time updates and cloud integration via wireless connectivity (e.g., via a 5G or LTE network).

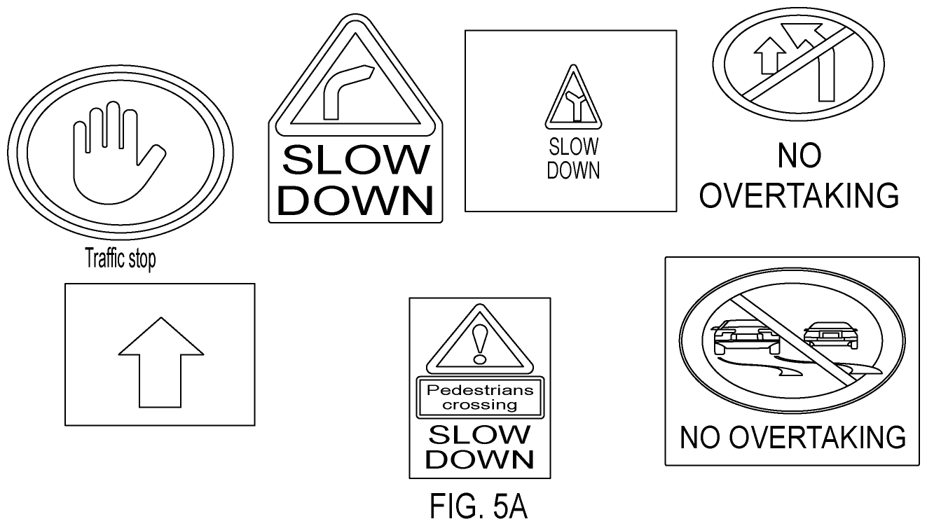

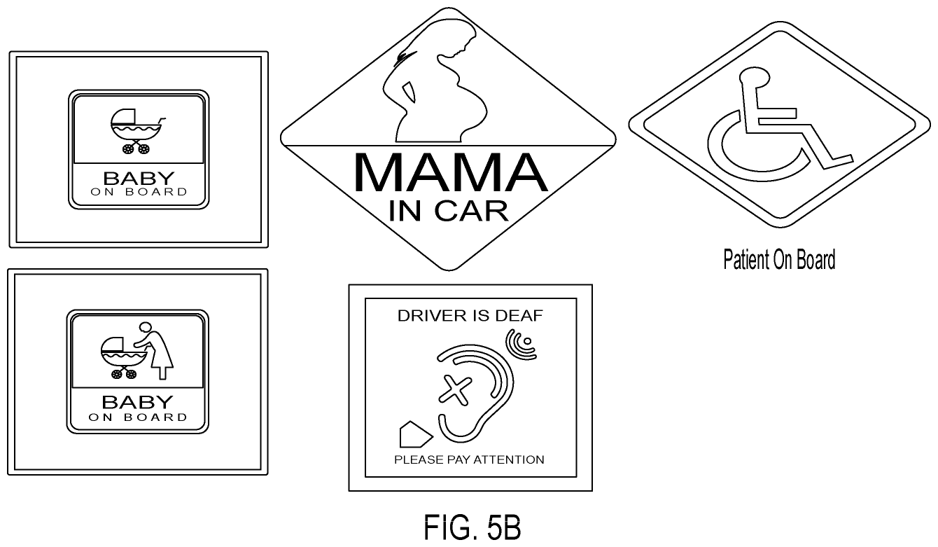

FIGS. 5A and 5B show example images or icons that may be displayed at the display device 22. For example, the system 12 may operate the display 22 based on determination that the vehicle 10 is approaching or is stopped at an intersection. The system 12 may determine that the vehicle 10 is at or near the intersection based on GPS signals, based on the vehicle speed slowing down, based on detecting a stop sign or traffic light via processing of image data, and the like. Further, the system 12 may determine a status of the intersection (e.g., red traffic light, pedestrian in a crosswalk, and the like) and display a message or icon based on the status of the intersection. The display 22 may show a message such as “pedestrian crossing,” “traffic stop,” and the like.

In some examples, the system 12 operates the display 22 only in response to determining presence of another vehicle or a pedestrian rearward of the vehicle 10. That is, the system 12 may not operate the display 22 when the equipped vehicle 10 is at or near an intersection or encounters another road condition based on the system 12 determining absence of other vehicles or pedestrians behind the equipped vehicle 10, and the system 12 only operates the display 22 when the other vehicle or pedestrian is detected. For example, the system 12 may determine presence of a following vehicle based on monitoring sensor data captured by one or more sensors that sense exterior of the vehicle 10 and at least rearward of the vehicle 10 (e.g., one or more radar sensors, ultrasonic sensors, lidar sensors, cameras, rear backup sensors or a rear backup camera, and the like). Similarly, the system 12 may determine presence of a pedestrian at least partially rearward of the vehicle 10 (e.g., walking alongside the road on which the vehicle 10 is traveling) based on monitoring sensor data captured by the one or more sensors that sense exterior of the vehicle 10 and at least rearward of the vehicle 10. This may ensure that the display 22 is operated to improve understanding of the intersection (or other road condition) ahead of the equipped vehicle 10 when other vehicles are detected while minimizing power use by the display 22 when no other vehicle or pedestrian is present to view the images at the display 22.

Further, the system 12 may only operate the display 22 in response to determining that the other vehicle is within a threshold distance of the equipped vehicle 10, and thus the driver of the other vehicle is more likely to have their view ahead of the equipped vehicle blocked by the equipped vehicle. For example, the system 12 may operate the display 22 in response to detecting presence of the other vehicle at a distance that is less than about 5 meters, less than about 3 meters, less than about 1.5 meters, less than about 1 meter, and the like.

When the vehicle 10 is travelling along the road, the system 12 may operate the display 22 based on a determined road condition. For example, based on detecting a curve in the road ahead of the vehicle 10, the system 12 may operate the display 22 to show a warning symbol or icon indicative of the curved road. The display 22 may show a message such as “slow down,” “curve ahead,” and the like.

Based on determining that the road ahead of the vehicle 10 (e.g., in the same lane of the vehicle and/or in a lane adjacent the vehicle) is clear of objects and other vehicles, and responsive to detecting an overtaking vehicle approaching the vehicle 10 from behind, the system 12 may operate the display 22 to indicate that the overtaking vehicle may overtake or pass the equipped vehicle 10. For example, the display 22 may show a forward facing arrow or a message such as “safe to pass.”

Additionally or alternatively, based on determining that the road ahead of the vehicle 10 (e.g., in the same lane of the vehicle and/or in a lane adjacent the vehicle) is not clear of objects and other vehicles (e.g., the lane is occupied by another vehicle, a pedestrian, or an object), and responsive to detecting another vehicle approaching the vehicle 10 from behind, the system 12 may operate the display 22 to indicate that the other vehicle should not overtake the equipped vehicle 10. For example, the display 22 may show a general prohibition sign overlayed on an image of a first vehicle overtaking a second vehicle, a caution sign, and/or a message such as “no overtaking.”

In some examples, the display 22 may display video images representative of the view forward of the vehicle 10, such that the driver of a following vehicle may view the road, other vehicles, or objects in front of the equipped vehicle 10. For example, the display device 22 may display video images generated based on image data captured by the forward viewing camera 14b, a windshield mounted camera, and the like.

Further, the system 12 may operate the display 22 based on a condition of the driver or occupant of the vehicle 10. For example, the system 12 may determine that a child or a baby is present within the interior cabin of the vehicle 10 and display an icon or message representative of the presence of the child or a baby. Similarly, the system 12 may detect presence of an elderly adult, a pregnant occupant, or a physically handicapped occupant and operate the display 22 accordingly. The system 12 may determine the condition of the driver or occupant based on an input from the driver or occupant and/or based on processing of image data captured by a driver monitoring system (DMS) or Occupant Monitoring System (OMS).

The display device 22 may be operated continuously, such as to display a status of the vehicle 10, or the display device 22 may be operated episodically or in response to a determination, such as to display a warning related to a condition ahead of the equipped vehicle 10.

Thus, the vehicular system 12 with the display device 22 at or near the rear window 24 of the vehicle 10 is configured to improve road safety with communication between vehicles. The system 12 integrates the display system on the rear windshield of the vehicle 10 to serve multiple purposes. For example, this display may show directional signals such as left or right turn signals, as well as a forward arrow indicating that it is safe for following vehicles to proceed in a straight line without overtaking. This could be beneficial at a T-intersection, a Y-intersection or a four-way intersection (e.g., an X-intersection), helping to prevent potential accidents.

Additionally, while the vehicle is stopped at a traffic light, the display may signal a “holding hand” symbol (FIG. 5A) until the light turns green. This feature could enhance understanding for drivers of following vehicles. Moreover, the display may accommodate information such as “baby onboard,” “mom onboard,” “patient onboard” for ambulances, and “emergency” or “caution” for a first response vehicle (e.g., an ambulance, a police vehicle, a fire fighting vehicle) when the first response vehicle is in service, ensuring that other drivers are aware of special circumstances regarding the vehicle (FIG. 5B). Implementing this system may significantly aid in communication on the roads, enhancing safety for all users and motorists.

That is, the automatic road sign and driver custom sign display for rear windshields may enhance driver awareness and promote safer driving practices. This allows drivers to receive crucial information and communicate effectively with others on the road, ultimately reducing the potential for accidents and improving road safety for everyone (e.g., drivers, vehicle occupants, pedestrians, and the like).

The camera or sensor may comprise any suitable camera or sensor. Optionally, the camera may comprise a “smart camera” that includes the imaging sensor array and associated circuitry and image processing circuitry and electrical connectors and the like as part of a camera module, such as by utilizing aspects of the vision systems described in U.S. Pat. Nos. 10,099,614 and/or 10,071,687, which are hereby incorporated herein by reference in their entireties.

The system includes an image processor operable to process image data captured by the camera or cameras, such as for detecting objects or other vehicles or pedestrians or the like in the field of view of one or more of the cameras. For example, the image processor may comprise an image processing chip selected from the EYEQ family of image processing chips available from Mobileye Vision Technologies Ltd. of Jerusalem, Israel, and may include object detection software (such as the types described in U.S. Pat. Nos. 7,855,755; 7,720,580 and/or 7,038,577, which are hereby incorporated herein by reference in their entireties), and may analyze image data to detect vehicles and/or other objects. Responsive to such image processing, and when an object or other vehicle is detected, the system may generate an alert to the driver of the vehicle and/or may generate an overlay at the displayed image to highlight or enhance display of the detected object or vehicle, in order to enhance the driver's awareness of the detected object or vehicle or hazardous condition during a driving maneuver of the equipped vehicle.

The vehicle may include any type of sensor or sensors, such as imaging sensors or radar sensors or lidar sensors or ultrasonic sensors or the like. The imaging sensor of the camera may capture image data for image processing and may comprise, for example, a two-dimensional array of a plurality of photosensor elements arranged in at least 640 columns and 480 rows (at least a 640×480 imaging array, such as a megapixel imaging array or the like), with a lens focusing images onto the imaging array. The photosensor array may comprise a plurality of photosensor elements arranged in a photosensor array having rows and columns. The imaging array may comprise a CMOS imaging array having at least 300,000 photosensor elements or pixels, preferably at least 500,000 photosensor elements or pixels and more preferably at least one million photosensor elements or at least two million photosensor elements or pixels or at least three million photosensor elements or pixels or at least five million photosensor elements or pixels arranged in rows and columns. The imaging array may be sensitive to near-infrared light. The imaging array may capture color image data, such as via spectral filtering at the array, such as via an RGB (red, green and blue) filter or via a red/red complement filter or such as via an RCC (red, clear, clear) filter or the like. The logic and control circuit of the imaging sensor may function in any known manner, and the image processing and algorithmic processing may comprise any suitable means for processing the images and/or image data.

For example, the vision system and/or processing and/or camera and/or circuitry may utilize aspects described in U.S. Pat. Nos. 9,233,641; 9,146,898; 9,174,574; 9,090,234; 9,077,098; 8,818,042; 8,886,401; 9,077,962; 9,068,390; 9,140,789; 9,092,986; 9,205,776; 8,917,169; 8,694,224; 7,005,974; 5,760,962; 5,877,897; 5,796,094; 5,949,331; 6,222,447; 6,302,545; 6,396,397; 6,498,620; 6,523,964; 6,611,202; 6,201,642; 6,690,268; 6,717,610; 6,757,109; 6,802,617; 6,806,452; 6,822,563; 6,891,563; 6,946,978; 7,859,565; 5,550,677; 5,670,935; 6,636,258; 7,145,519; 7,161,616; 7,230,640; 7,248,283; 7,295,229; 7,301,466; 7,592,928; 7,881,496; 7,720,580; 7,038,577; 6,882,287; 5,929,786 and/or 5,786,772, and/or U.S. Publication Nos. US-2014-0340510; US 2014-0313339; US-2014-0347486; US-2014-0320658; US-2014-0336876; US-2014-0307095; US-2014-0327774; US-2014-0327772; US-2014-0320636; US-2014-0293057; US-2014-0309884; US-2014-0226012; US-2014-0293042; US-2014-0218535; US-2014-0218535; US-2014-0247354; US-2014-0247355; US-2014-0247352; US-2014-0232869; US-2014-0211009; US-2014-0160276; US-2014-0168437; US-2014-0168415; US-2014-0160291; US-2014-0152825; US-2014-0139676; US-2014-0138140; US-2014-0104426; US-2014-0098229; US-2014-0085472; US-2014-0067206; US-2014-0049646; US-2014-0052340; US-2014-0025240; US-2014-0028852; US-2014-005907; US-2013-0314503; US-2013-0298866; US-2013-0222593; US-2013-0300869; US-2013-0278769; US-2013-0258077; US-2013-0258077; US-2013-0242099; US-2013-0215271; US-2013-0141578 and/or US-2013-0002873, which are all hereby incorporated herein by reference in their entireties. The system may communicate with other communication systems via any suitable means, such as by utilizing aspects of the systems described in U.S. Pat. Nos. 10,071,687; 9,900,490; 9,126,525 and/or 9,036,026, which are hereby incorporated herein by reference in their entireties.

Optionally, the camera may comprise a forward-viewing camera, such as disposed at a windshield electronics module (WEM) or the like. The forward-viewing camera may utilize aspects of the systems described in U.S. Pat. Nos. 12,174,448; 11,635,672; 11,124,130; 9,896,039; 9,871,971; 9,596,387; 9,487,159; 8,256,821; 7,480,149; 6,824,281 and/or 6,690,268, which are all hereby incorporated herein by reference in their entireties.

The system may utilize sensors, such as radar sensors or imaging radar sensors or lidar sensors or the like, to detect presence of and/or range to objects and/or other vehicles and/or pedestrians. The sensing system may utilize aspects of the systems described in U.S. Pat. Nos. 10,866,306; 9,954,955; 9,869,762; 9,753,121; 9,689,967; 9,599,702; 9,575,160; 9,146,898; 9,036,026; 8,027,029; 8,013,780; 7,408,627; 7,405,812; 7,379,163; 7,379,100; 7,375,803; 7,352,454; 7,340,077; 7,321, 111; 7,310,431; 7,283,213; 7,212,663; 7,203,356; 7,176,438; 7,157,685; 7,053,357; 6,919,549; 6,906,793; 6,876,775; 6,710,770; 6,690,354; 6,678,039; 6,674,895 and/or 6,587,186, and/or U.S. Publication Nos. US-2019-0339382; US-2018-0231635; US-2018-0045812; US-2018-0015875; US-2017-0356994; US-2017-0315231; US-2017-0276788; US-2017-0254873; US-2017-0222311 and/or US-2010-0245066, which are hereby incorporated herein by reference in their entireties.

The radar sensors of the sensing system each comprise a plurality of transmitters that transmit radio signals via a plurality of antennas, a plurality of receivers that receive radio signals via the plurality of antennas, with the received radio signals being transmitted radio signals that are reflected from an object present in the field of sensing of the respective radar sensor. The system includes an ECU or control that includes a data processor for processing sensor data captured by the radar sensors. The ECU or sensing system may be part of a driving assist system of the vehicle, with the driving assist system controlling at least one function or feature of the vehicle (such as to provide autonomous driving control of the vehicle) responsive to processing of the data captured by the radar sensors.

The radar sensor or sensors may be disposed at the vehicle so as to sense exterior of the vehicle. For example, the radar sensor may comprise a front or forward-sensing radar sensor mounted at a grille or front bumper of the vehicle, such as for use with an automatic emergency braking system of the vehicle, an adaptive cruise control system of the vehicle, a collision avoidance system of the vehicle, etc., or the radar sensor may be comprise a corner radar sensor disposed at a front corner or rear corner of the vehicle, such as for use with a surround vision system of the vehicle, or the radar sensor may comprise a blind spot monitoring radars disposed at a rear fender of the vehicle for monitoring sideward/rearward of the vehicle for a blind spot monitoring and alert system of the vehicle. Optionally, the radar sensor or sensors may be disposed within the vehicle so as to sense interior of the vehicle, such as for use with a cabin monitoring system of the vehicle or a driver monitoring system of the vehicle or an occupant detection or monitoring system of the vehicle. The radar sensing system may comprise multiple input multiple output (MIMO) radar sensors having multiple transmitting antennas and multiple receiving antennas.

The system may utilize aspects of driver monitoring systems and/or head and face direction and position tracking systems and/or eye tracking systems and/or gesture recognition systems. Such head and face direction and/or position tracking systems and/or eye tracking systems and/or gesture recognition systems may utilize aspects of the systems described in U.S. Pat. Nos. 12,403,834; 12,393,089; 11,827,153; 11,780,372; 11,639,134; 11,582,425; 11,518,401; 10,958,830; 10,065,574; 10,017,114; 9,405,120 and/or 7,914,187, and/or U.S. Publication Nos. US-2025-0329174; US-2024-0383406; US-2024-0190456; US-2024-0168355; US-2022-0377219; US-2022-0254132; US-2022-0242438; US-2021-0323473; US-2021-0291739; US-2020-0320320; US-2020-0202151; US-2020-0143560; US-2019-0210615; US-2018-0231976; US-2018-0222414; US-2017-0274906; US-2017-0217367; US-2016-0209647; US-2016-0137126; US-2015-0352953; US-2015-0296135; US-2015-0294169; US-2015-0232030; US-2015-0092042; US-2015-0022664; US-2015-0015710; US-2015-0009010 and/or US-2014-0336876, and/or International Publication Nos. WO 2026/019985 and/or WO 2025/231198, which are all hereby incorporated herein by reference in their entireties.

The interior-viewing camera may be disposed at the mirror head of the interior rearview mirror assembly and moves together and in tandem with the mirror head when the driver of the vehicle adjusts the mirror head to adjust his or her rearward view. The interior-viewing camera may be disposed at a lower or chin region of the mirror head below the mirror reflective element of the mirror head, or the interior-viewing camera may be disposed behind the mirror reflective element and viewing through the mirror reflective element. Similarly, the light emitter may be disposed at the lower or chin region of the mirror head below the mirror reflective element of the mirror head (such as to one side or the other of the interior-viewing camera), or the light emitter may be disposed behind the mirror reflective element and emitting light that passes through the mirror reflective element. The ECU may be disposed at the mirror assembly (such as accommodated by the mirror head), or the ECU may be disposed elsewhere in the vehicle remote from the mirror assembly, whereby image data captured by the interior-viewing camera may be transferred to the ECU via a coaxial cable or other suitable communication line. Cabin monitoring or occupant detection may be achieved via processing at the ECU of image data captured by the interior-viewing camera. Optionally, cabin monitoring or occupant detection may be achieved in part via processing at the ECU of radar data captured by one or more interior-sensing radar sensors disposed within the vehicle and sensing the interior cabin of the vehicle.

Optionally, the driver monitoring system may be integrated with a camera monitoring system (CMS) of the vehicle. The integrated vehicle system incorporates multiple inputs, such as from the inward-viewing or driver monitoring camera and from the forward-viewing camera, as well as from a rearward-viewing camera and sideward-viewing cameras of the CMS (e.g., a rearward-viewing camera disposed at the rear of the vehicle remote from the rear backup camera of the vehicle, and rearward-viewing cameras disposed at respective sides of the vehicle, such as at respective side-mounted exterior rearview mirror assemblies of the vehicle), to provide the driver with unique collision mitigation capabilities based on full vehicle environment and driver awareness state. The rearward-viewing camera may comprise a rear backup camera of the vehicle or may comprise a centrally located higher mounted camera (such as at a center high-mounted stop lamp (CHMSL) of the vehicle), whereby the rearward-viewing camera may view rearward and downward toward the ground at and rearward of the vehicle. The image processing and detections and determinations are performed locally within the interior rearview mirror assembly and/or the overhead console region, depending on available space and electrical connections for the particular vehicle application. The CMS cameras and system may utilize aspects of the systems described in U.S. Pat. No. 11,242,008 and/or U.S. Publication Nos. US-2024-0064274; US-2021-0245662; US-2021-0162926; US-2021-0155167; US-2018-0134217 and/or US-2014-0285666, which are all hereby incorporated herein by reference in their entireties.

The ECU may receive image data captured by a plurality of cameras of the vehicle, such as by a plurality of surround view system (SVS) cameras and a plurality of camera monitoring system (CMS) cameras and optionally one or more driver monitoring system (DMS) cameras. The ECU may comprise a central or single ECU that processes image data captured by the cameras for a plurality of driving assist functions and may provide display of different video images to a video display screen in the vehicle (such as at an interior rearview mirror assembly or at a central console or the like) for viewing by a driver of the vehicle. The system may utilize aspects of the systems described in U.S. Pat. Nos. 11,242,008; 10,442,360 and/or 10,046,706, and/or U.S. Publication Nos. US-2024-0064274; US-2021-0245662; US-2021-0162926; US-2021-0155167 and/or US-2019-0118717, which are all hereby incorporated herein by reference in their entireties.

Optionally, the vision system may include a display for displaying images captured by one or more of the imaging sensors for viewing by the driver of the vehicle while the driver is normally operating the vehicle. Optionally, for example, the vision system may include a video display device, such as by utilizing aspects of the video display systems described in U.S. Pat. Nos. 5,530,240; 6,329,925; 7,855,755; 7,626,749; 7,581,859; 7,446,650; 7,338,177; 7,274,501; 7,255,451; 7,195,381; 7,184,190; 5,668,663; 5,724,187; 6,690,268; 7,370,983; 7,329,013; 7,308,341; 7,289,037; 7,249,860; 7,004,593; 4,546,551; 5,699,044; 4,953,305; 5,576,687; 5,632,092; 5,708,410; 5,737,226; 5,802,727; 5,878,370; 6,087,953; 6,173,501; 6,222,460; 6,513,252 and/or 6,642,851, and/or U.S. Publication Nos. US-2014-0022390; US-2012-0162427; US-2006-0050018 and/or US-2006-0061008, which are all hereby incorporated herein by reference in their entireties.

Changes and modifications in the specifically described embodiments can be carried out without departing from the principles of the invention, which is intended to be limited only by the scope of the appended claims, as interpreted according to the principles of patent law including the doctrine of equivalents.

1. A vehicular sensing system, the vehicular sensing system comprising:
a sensor disposed at a vehicle equipped with the vehicular sensing system, wherein the sensor senses exterior of the equipped vehicle and at least forward of the equipped vehicle, and wherein the sensor is operable to capture sensor data;
an electronic control unit (ECU);
wherein the ECU comprises electronic circuitry and associated software;
wherein the electronic circuitry of the ECU comprises a data processor for processing sensor data captured by the sensor and transferred to the ECU;
a display device disposed at a rear window of the equipped vehicle, wherein the display device, when electrically operated to display images, displays images that are viewable by a person exterior of the equipped vehicle and at least rearward of the equipped vehicle;
wherein the vehicular sensing system, based on the equipped vehicle being at or near an intersection of a road, and via processing at the ECU of sensor data captured by the sensor and transferred to the ECU, determines a condition of the intersection; and
wherein, responsive to determination that another vehicle is present rearward of the equipped vehicle, the vehicular sensing system operates the display device to display an image that is representative of the determined condition of the intersection.

2. The vehicular sensing system of claim 1, wherein the determined condition comprises presence of a pedestrian at the intersection.

3. The vehicular sensing system of claim 1, wherein the determined condition comprises a status of a traffic light at the intersection.

4. The vehicular sensing system of claim 1, wherein the determined condition comprises a clear intersection.

5. The vehicular sensing system of claim 1, wherein the display device comprises an at least partially transparent display device such that a driver of the equipped vehicle views through the at least partially transparent display device and the rear window when viewing exterior of the equipped vehicle and rearward of the equipped vehicle.

6. The vehicular sensing system of claim 5, wherein the at least partially transparent display device comprises an organic light emitting diode display device.

7. The vehicular sensing system of claim 1, wherein the sensor comprises one selected from the group consisting of (i) a radar sensor, (ii) a lidar sensor and (iii) an ultrasonic sensor.

8. The vehicular sensing system of claim 1, wherein the sensor comprises a camera that views exterior of the equipped vehicle and at least forward of the equipped vehicle.

9. The vehicular sensing system of claim 8, wherein the vehicular sensing system, via processing at the ECU of image data captured by the camera and transferred to the ECU, operates the display device to display a video image representative of a view forward of the equipped vehicle.

10. The vehicular sensing system of claim 1, wherein the vehicular sensing system determines presence of the other vehicle rearward of the equipped vehicle via processing at the ECU of sensor data captured by a rearward sensing sensor disposed at the equipped vehicle and sensing exterior of the equipped vehicle and at least rearward of the equipped vehicle.

11. The vehicular sensing system of claim 10, wherein the vehicular sensing system operates the display device to display the image based on determination that the other vehicle is at a distance from the equipped vehicle that is less than a threshold distance.

12. The vehicular sensing system of claim 1, wherein the vehicular sensing system, as the equipped vehicle travels along the road, and via processing at the ECU of sensor data captured by the sensor and transferred to the ECU, determines a condition of the road, and wherein the vehicular sensing system operates the display device to display an image that is representative of the determined condition of the road.

13. The vehicular sensing system of claim 12, wherein the vehicular sensing system operates the display device to display the image that is representative of the determined condition of the road responsive to determination that the other vehicle is present rearward of the equipped vehicle.

14. The vehicular sensing system of claim 1, wherein the vehicular sensing system operates the display device to display an image that is representative of a condition of an occupant of the equipped vehicle, and wherein the vehicular sensing system determines the condition of the occupant of the equipped vehicle based on processing of image data captured by an occupant monitoring camera of the equipped vehicle.

15. The vehicular sensing system of claim 1, wherein the vehicular sensing system operates the display device to display the image that is representative of the determined condition of the intersection in response to a user input.

16. A vehicular sensing system, the vehicular sensing system comprising:
a sensor disposed at a vehicle equipped with the vehicular sensing system, wherein the sensor senses exterior of the equipped vehicle and at least forward of the equipped vehicle, and wherein the sensor is operable to capture sensor data;
an electronic control unit (ECU);
wherein the ECU comprises electronic circuitry and associated software;
wherein the electronic circuitry of the ECU comprises a data processor for processing sensor data captured by the sensor and transferred to the ECU;
an at least partially transparent display device disposed at a rear window of the equipped vehicle, wherein the at least partially transparent display device, when electrically operated to display images, displays images that are viewable by a person exterior of the equipped vehicle and at least rearward of the equipped vehicle, and wherein a driver of the equipped vehicle views through the at least partially transparent display device and the rear window when viewing exterior of the equipped vehicle and rearward of the equipped vehicle;
wherein the vehicular sensing system, based on the equipped vehicle being at or near an intersection of a road, and via processing at the ECU of sensor data captured by the sensor and transferred to the ECU, determines a condition of the intersection;
wherein the vehicular sensing system determines presence of another vehicle rearward of the equipped vehicle via processing at the ECU of sensor data captured by a rearward sensing sensor disposed at the equipped vehicle and sensing exterior of the equipped vehicle and at least rearward of the equipped vehicle; and
wherein, responsive to determination that the other vehicle is present rearward of the equipped vehicle, and based on determination that the other vehicle is at a distance from the equipped vehicle that is less than a threshold distance, the vehicular sensing system operates the at least partially transparent display device to display an image that is representative of the determined condition of the intersection.

17. The vehicular sensing system of claim 16, wherein the vehicular sensing system, as the equipped vehicle travels along the road, and via processing at the ECU of sensor data captured by the sensor and transferred to the ECU, determines a condition of the road, and wherein the vehicular sensing system operates the at least partially transparent display device to display an image that is representative of the determined condition of the road.

18. The vehicular sensing system of claim 16, wherein the vehicular sensing system operates the at least partially transparent display device to display an image that is representative of a condition of an occupant of the equipped vehicle, and wherein the vehicular sensing system determines the condition of the occupant of the equipped vehicle based on processing of image data captured by an occupant monitoring camera of the equipped vehicle.

19. A vehicular sensing system, the vehicular sensing system comprising:
a camera disposed at a vehicle equipped with the vehicular sensing system, wherein the camera views exterior of the equipped vehicle and at least forward of the equipped vehicle, and wherein the camera is operable to capture image data;
an electronic control unit (ECU);
wherein the ECU comprises electronic circuitry and associated software;
wherein the electronic circuitry of the ECU comprises an image processor for processing image data captured by the camera and transferred to the ECU;
an at least partially transparent display device disposed at a rear window of the equipped vehicle, wherein the at least partially transparent display device, when electrically operated to display images, displays images that are viewable by a person exterior of the equipped vehicle and at least rearward of the equipped vehicle, and wherein a driver of the equipped vehicle views through the at least partially transparent display device and the rear window when viewing exterior of the equipped vehicle and rearward of the equipped vehicle;
wherein the vehicular sensing system, as the equipped vehicle travels along a road, and via processing at the ECU of image data captured by the camera and transferred to the ECU, determines a condition of the road; and
wherein, responsive to determination that another vehicle is present rearward of the equipped vehicle, and based on the determined condition of the road, the vehicular sensing system operates the at least partially transparent display device to display a video image that is representative of a view forward of the equipped vehicle.

20. The vehicular sensing system of claim 19, wherein the determined condition of the road comprises at least one selected from the group consisting of (i) presence of a leading vehicle forward of the equipped vehicle, (ii) a curve in the road, (iii) an intersection of the road.
